(19) United States
(12) Patent Application Publication
(10) Pub. No.: US 2003/0205569 A1
(43) Pub. Date: Nov. 6, 2003

(54) Dual-purpose pot for roasting and frying

(76) Inventor: Kwei Tang Chang, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/138,414

(22) Filed: May 6, 2002

(51) Int. Cl. A21B 1/22; F27D 11/00

(52) U.S. Cl. 219/400; 219/430

(57) ABSTRACT

The present invention provide a dual-purpose pot for roasting and frying, which comprises a main body, a pot body, an electric heat pipe, a fan, and a frying net. The top portion of the main body is open, and an upper cover capable of opening and closing is disposed at the top portion of the main body. The pot body is disposed in the main body. The electric heat pipe is disposed inside the pot body. The fan is disposed at the inside of the upper cover. The fan comprises a motor and a fan blade. The motor is fixed at the inside of the upper cover. The fan blade is fixed with a power output shaft of the motor.

### FIELD OF THE INVENTION

The present invention relates to a dual-purpose pot for roasting and frying and, more particularly, to a dual-purpose pot having both roasting and frying functions.

### BACKGROUND OF THE INVENTION

Along with progress of society, the pace of life tends to quicker. People more and more appreciate efficiencies in life and work. Conventional single-function. articles cannot meet the requirements of modern customers in design and are gradually eliminated through competition. Various kinds of electric appliances and accessories have thus been developed for replacement.

Conventional pots have no both roasting and frying functions. Because roasting and frying are commonly used ways in treatment of food, one thus must buy two pots of different usage (e.g., a roasting oven and a frying pan) for roasting and frying, respectively. In addition to increase economic burdens to the user, these two kinds of pots will occupy more space, resulting in inconvenient storage.

Accordingly, the above conventional pots have inconvenience and drawbacks in practical use. The present invention aims to resolve the problems in the prior art.

### SUMMARY OF THE INVENTION

The primary object of the present invention is to provide a dual-purpose pot for roasting and frying, which has both roasting and frying functions. In addition to lessening economic burdens to the user, the pot of the present invention will save space to facilitate storage.

To achieve the above object, the present invention provide a dual-purpose pot for roasting and frying, which comprises a main body, a pot body, an electric heat pipe, and a fan. The top portion of the main body is open, and an upper cover is disposed at the top portion of the main body. The pot body is disposed in the main body. The electric heat pipe is disposed inside the pot body. The fan is disposed at the inside of the upper cover.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of the present invention;

FIG. 2 is a cross-sectional view of the present invention;

FIG. 3 is a detailed perspective view of a detachable fan of the present invention;

FIG. 4 is a perspective view of an upper cover of the present invention;

FIG. 5 is a perspective view of a panel of the present invention; and

FIG. 6 is a cross-sectional view according to another embodiment of the present invention.

### DETAILED DESCRIPTION OF THE PREFERRED EMBODIMENTS

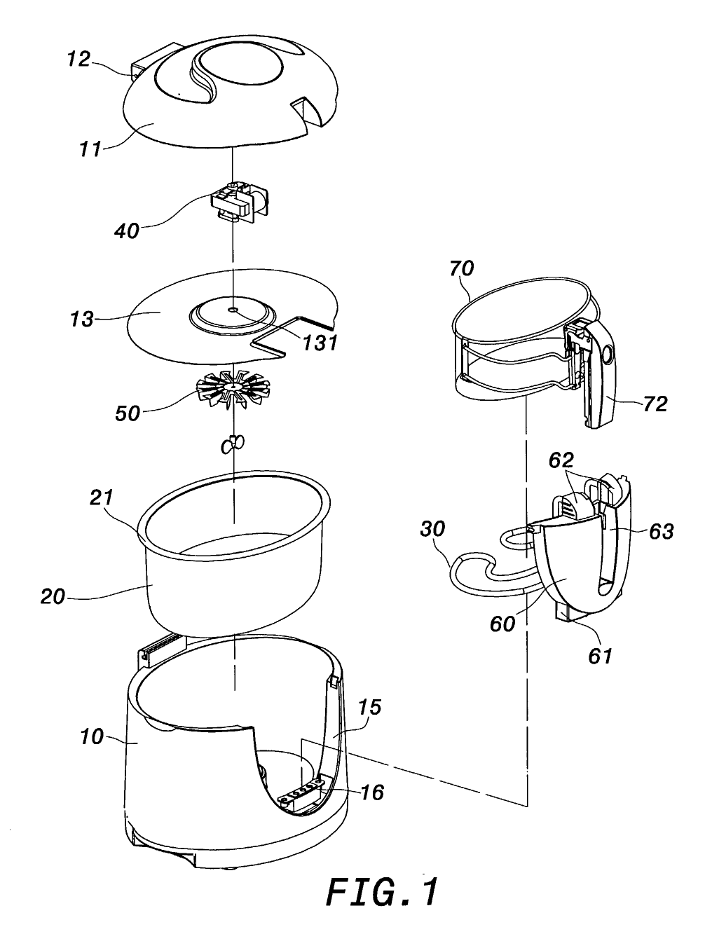

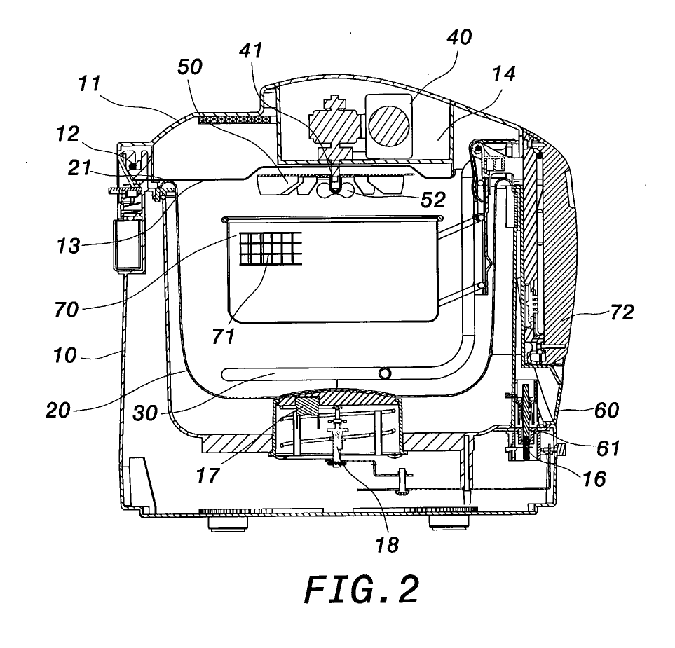

As shown in FIGS. 1 and 2, the present invention provides a dual-purpose pot for roasting and frying, which comprises a main body 10, a pot body 20, an electric heat pipe 30, a motor 40, and a fan blade 50. The main body 10 is a hollow shell body having an open top portion, and an upper cover 11 is disposed at the top portion of the main body 10. One side of the upper cover is pivotally joined with the main body via a hinge 12 so that the upper cover 11 can be opened or closed. A cover board 13 is fixed at the inner side of the upper cover 11. A receiving space 14 of motor is formed between the cover board 14 and the upper cover 11. An indentation 15 is opened on the sidewall of the main body 10. A first lower connector 16 is disposed at the bottom portion of the indentation 15. An over heat protection temperature-control device 17 and a temperature controller 18 are disposed at the bottom portion inside the main body 10. The first lower connector 16 achieves electric connection with the over heat protection temperature-control device 17 and the temperature controller 18.

The pot body 20 is made of refractory material like metal. The pot body 20 is a hollow pot body with an open top portion. A flange 21 is formed at the edge of the top portion of the pot body 20. The pot body 20 is positioned at a predetermined height in the main body 10.

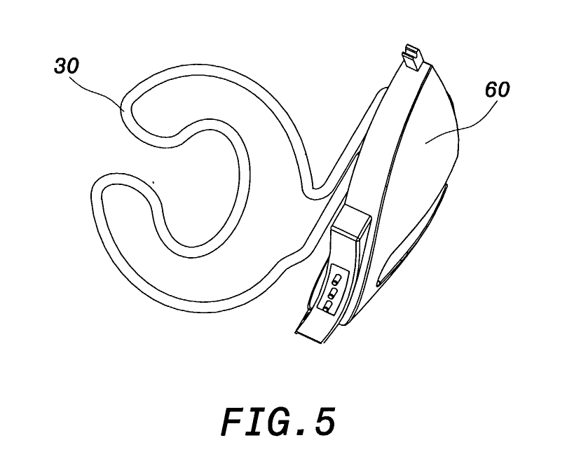

The electric heat pipe 30 is disposed near the bottom portion in the pot body 20. The electric heat pipe 30 is fixed on a panel 60 in advance, as shown in FIG. 5. The shape of the panel 60 corresponds to the indentation 15 on the sidewall of the main body 10. The panel 60 is embedded in the indentation 15. A first upper connector 61 is disposed at the bottom portion of the panel 60. The first upper connector 61 achieves electric connection with a control circuit (not shown) in the panel 60. The first upper connector 61 is plugged with the first lower connector 16 to let the over heat protection temperature-control device 17 and the temperature controller 18 achieve electric connection with the control circuit. The over heat protection temperature-control device 17 and the temperature controller 18 can thus control the heating temperature of the electric heat pipe 30.

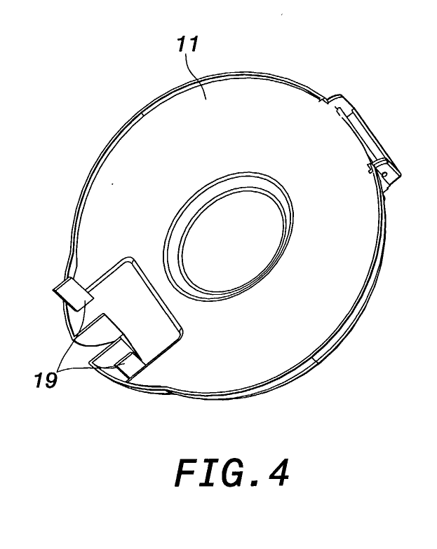

A second lower connector 62 is disposed at the top portion of the panel 60. The second lower connector 62 achieves electric connection with the control circuit (not shown) in the panel 60. A second upper connector 19 is disposed on the upper cover 12, as shown in FIG. 4. The second upper connector 19 achieves electric connection with the motor 40. The second upper connector 19 is plugged with the second lower connector 62 to let the motor 40 achieve electric connection with the control circuit.

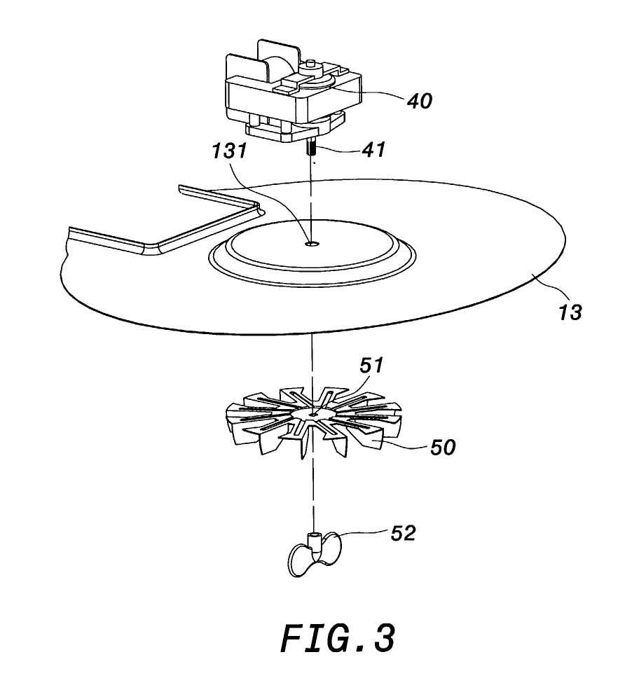

The motor 40 is disposed in the receiving space 14 at the inside of the upper cover 11, and is properly fixed in a way such as screwing. A power output shaft 41 of the motor 40 passes downwards through a through hole 131 preset on the cover board 13 and sticks to above the pot body 20, as shown in FIG. 3.

A central hole 51 of the fan blade 50 is matched with the power output shaft 41 of the motor 40. The power output shaft 41 passes through the central hole 51 and is then screwed to a detachable nut 52, thereby forming a fan. The fan blade 50 is fixed on the power output shaft 41 in detachable way. The fan blade 50 can be properly driven by the motor 40 to make rotation.

A frying net 70 can be disposed inside the pot body 20. The frying net 70 is made of refractory material like metal. The frying net 70 is a hollow body with an open top portion. Meshes 71 are distributed on the frying net 70. The frying net 70 is disposed at a predetermined height above the electric heat pipe 30. A handle 72 is disposed at one side of the frying net 70. The handle 72 is matched in a groove 63 preset on the panel 60. A dual-purpose pot for roasting and frying of the present invention is thus formed.

In the present invention, when food is to be roasted, the fan blade 50 needs to be installed, and it is not necessary to add in any frying oil in the pot body 20. This function is like that of a roasting oven. Food is first placed in the pot body 20. Next, the upper cover 11 is covered. The electric heat pipe 30 and the motor 40 are then activated to let the fan blade 50 rotate. High heat generated by the electric heat pipe 30 can thus be transferred to the food. Moreover, hot air generated by the electric heat pipe 30 can be blown by the fan blade 50 to flow upwards along the inner wall of the pot body 20, thereby forming circulatory flow of hot air and roasting the food until the food is fully cooked.

When food is to be fried, it is necessary to detach the fan blade 50, and frying oil of appropriate amount is added in the pot body 20. Next, the food is placed in the frying net 70 in the pot body 20. The electric heat pipe 30 is then activated to generate high heat, thereby performing the operation of frying food. This function is like that of a common frying pan.

Because a fan is used when roasting food, the culinary effect, time, and flavor are the same as those achieved by frying. Because there is no frying oil used, the food will not be too oily. There is no doubt about health. Moreover, in the present invention, food is sealed in the pot, and high heat generated by the electric heat pipe 30 can be blown with the fan blade 50 to form circulatory flow. Therefore, food can be uniformly and fast heated, hence greatly shortening the cooking time of food.

To sum up, the present invention has both roasting (cooking without oil) and frying functions. One needs not to buy two pots of different usage. In addition to lessening economic burdens to the user, the present invention can save space to facilitate storage, hence meeting the requirements of modern people.

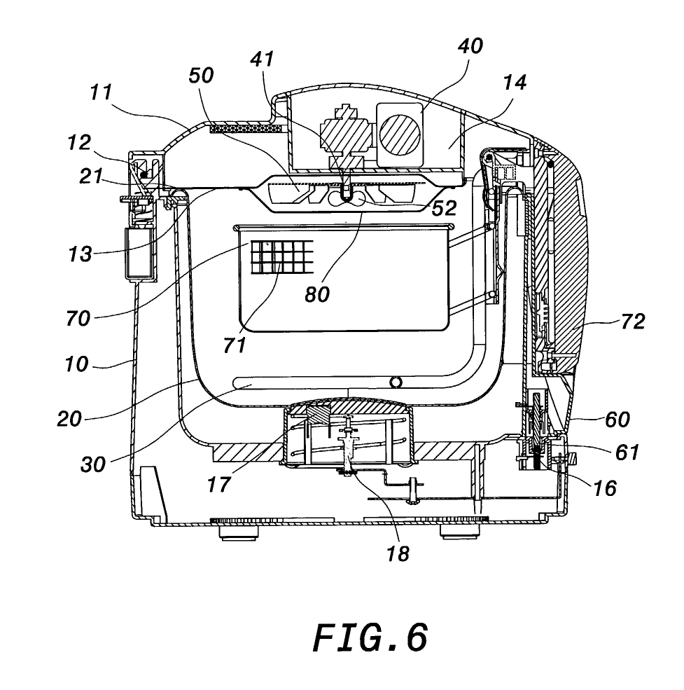

Besides, as shown in FIG. 6, in addition to the detachable design of the fan blade 50, the fan can adopt a fixed design. In other words, the fan blade 50 is fixed on the power output shaft 41 in non-detachable way. In this embodiment, it is not necessary to take down the fan blade 50 when frying food. It is only necessary to cover a metal lid 80 outside the fan blade 50. The metal lid 80 is fixed on the cover board 13 at the inside of the upper cover 11 in detachable way like retaining or screwing. When food is to be roasted, it is only necessary to detach the metal lid 80.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A dual-purpose pot for roasting and frying, comprising:
a main body with an open top portion, an upper cover being disposed on the top portion of said main body;
a pot body disposed in said main body;
an electric heat pipe disposed in said pot body; and
a fan disposed at an inside of said upper cover.

2. The dual-purpose pot for roasting and frying as claimed in claim 1, wherein an indentation is disposed on a sidewall of said main body, a first lower connector is disposed at a bottom portion of said indentation, a over heat protection temperature control device and a temperature controller are disposed at a lower portion inside said main body, said electric heat pipe is fixed on a panel embedded in said indentation, a first upper connector is disposed at a bottom portion of said panel, said first upper connector is plugged with said first lower connector.

3. The dual-purpose pot for roasting and frying as claimed in claim 2, wherein a second lower connector is disposed at a top portion of said panel, a second upper connector is disposed on said upper cover, said second upper connector is plugged with said second lower connector.

4. The dual-purpose pot for roasting and frying as claimed in claim 1, wherein one side of said upper cover is pivotally joined with said main body with a hinge.

5. The dual-purpose pot for roasting and frying as claimed in claim 1, wherein a frying net with an open top portion is disposed in said pot body, said frying net is disposed above said electric heat pipe, a handle is disposed at one side of said frying net.

6. The dual-purpose pot for roasting and frying as claimed in claim 1, wherein said fan is a detachable fan disposed at the inside of said upper cover in detachable way.

7. The dual-purpose pot for roasting and frying as claimed in claim 6, wherein said detachable fan comprises a motor and a fan blade, a cover board is fixed at the inside of said upper cover, a receiving space is formed between said cover board and said upper cover, said motor is fixed in said receiving space, a power output shaft of said motor passes through said cover board and sticks to above said pot body, a central hole of said fan blade is matched with said power output shaft of said motor, said power output shaft is screwed to a detachable nut.

8. The dual-purpose pot for roasting and frying as claimed in claim 1, wherein a metal lid covers outside said fan, and said metal lid is fixed at the inside of said upper cover in detachable way.
